(19) United States
(12) Patent Application Publication
(10) Pub. No.: US 2009/0179508 A1
(43) Pub. Date: Jul. 16, 2009

(54) SOUNDPROOF SHREDDER MOTOR

(76) Inventor: SIMON HUANG, SanChung City (TW)

Correspondence Address: STEFAN KIRCHANSKI, VENABLE LLP 2049 CENTURY PARK EAST, 21ST FLOOR, LOS ANGELES, CA, 90067, US

(21) Appl. No.: 12/350,876

(22) Filed: Jan. 8, 2009

(30) Foreign Application Priority Data
Jan. 11, 2008 (CN) 200820042716.8

(51) Int. Cl. H02K 5/24

(52) U.S. Cl. 310/51

(57) ABSTRACT

The present invention discloses a soundproof shredder motor. The motor includes a soundproof mask which surrounds the contact between the rotor and carbon brush. The soundproof mask includes an inner mask and an outer mask formed with holes arranged in an alternating fashion. The disclosed motor soundproof mask encloses the frictional interaction between the rotor and the carbon brush, thereby reducing the noise resulting from the contact. Additionally, since the mask is located near the noise source, it occupies a small space and is less expensive to manufacture. The mask also serves to contain sparks.

### CROSS-REFERENCE TO PRIOR APPLICATIONS

This application claims priority to Foreign Application No. 200820042716.8 filed in P.R. China on Jan. 11, 2008.

### BACKGROUND OF THE INVENTION

1. Area of the Art

This invention relates to a shredder motor and, in particular, to a mask which enables a soundproof shredder motor.

2. Description of the Background Art

Improper processing of waste paper is problematic, even resulting in serious security issues. In some instances, waste documents are burnt to maintain security. In that case, a special place for burning is required, and such burning pollutes the environment. Shredders were invented to alleviate the security problem surrounding the disposal of paper documents.

Currently on the market are electric shredders driven by AC motors. The rotor and the carbon brush of the motor maintain an elastic contact. When the rotor is driven to rotate at a high speed, the contact between the carbon brush and the rotor can be very noisy.

### SUMMARY OF THE INVENTION

In view of the foregoing, the invention provides a soundproof shredder motor.

The disclosed motor includes: a back frame; a rotor; a carbon brush in elastic contact with the rotor; and a soundproof mask disposed surrounding the contact region between the rotor and the carbon brush; wherein the soundproof mask includes an inner mask and an outer mask that is formed with small holes arranged in an alternating fashion.

The inner mask and the outer mask of the soundproof mask are ring shaped and are formed with passage openings at the position corresponding to the carbon brush so that the carbon brush passes through to contact the rotor. Moreover, there are gaps between the inner mask and the outer mask.

The front end and the rear end of the soundproof mask interact with a first elastic sealing element and a second elastic sealing element, respectively, to close the gaps between the mask ends and the rotor.

The invention uses the soundproof mask to enclose the frictional portion of the rotor and the carbon brush. When noise produced by frictional contact between the rotor and the carbon brush reaches the soundproof mask, it is greatly attenuated by the interference of sound waves due to the alternately arranged small holes on the inner mask and the outer mask. Therefore, the invention achieves the desired result of blocking noise. Moreover, because the soundproof mask is located near the noise source, it occupies only a small space which minimizes production cost.

In addition, the invention can contain sparks in a confined area. Sparks are likely to form at the frictional interaction of the rotor and the carbon brush. This invention encloses this area thus blocking any sparks.

In summary, the invention is advantageous because it is a simple structure that decreases noise and increases safety by blocking sparks. It thus has good utility and is very competitive on the market.

All of the foregoing operational principles and advantages of the present invention will be more fully appreciated upon consideration of the following detailed description with reference to the drawings.

### DESCRIPTION OF THE FIGURES

The features and advantages of this invention are better understood with regard to the following drawings, description, and claims. The drawings consist of the following:

FIG. 1 is a schematic three-dimensional view of the invention;

FIG. 2 is a side view of the invention; and

FIG. 3 is a perspective view of the invention.

### DETAILED DESCRIPTION OF THE INVENTION

The following description is provided to enable any person skilled in the art to make and use the invention and sets forth the best modes contemplated by the inventor of carrying out his invention.

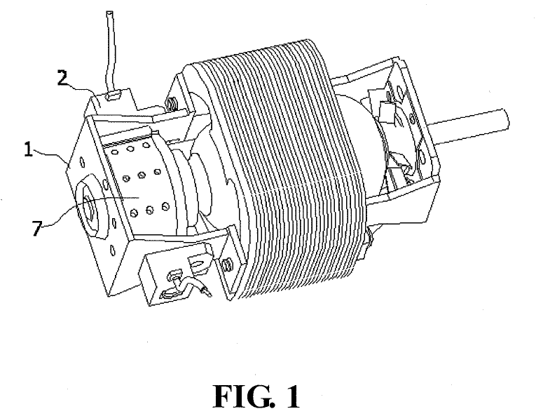

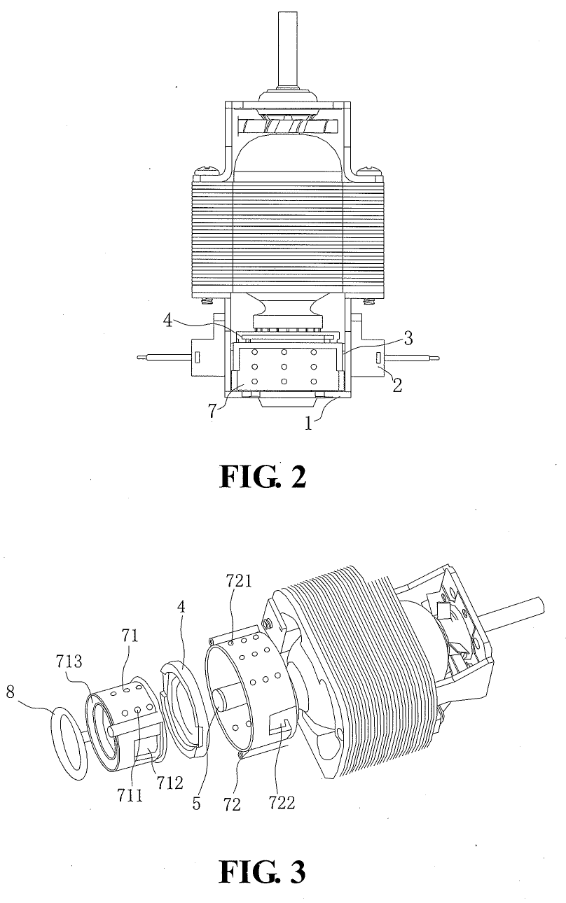

Please refer to FIGS. 1, 2, and 3. The disclosed motor includes a back frame 1, a fixing element 2, a carbon brush 3 fixed by the fixing element 2, a rotor 5, and a soundproof mask 7. The soundproof mask 7 reduces the noise produced due to friction between the rotor 5 and the carbon brush 3. Therefore, the invention can attenuate the noise from the rotor 5 and the carbon brush 3 during the operation of the motor.

The soundproof mask 7 is disposed around the rotor 5 and the carbon brush 3 extends through passage openings in the mask 7.

The soundproof mask 7 preferably includes an inner mask 71 and an outer mask 72 mounted together with a small gap therebetween. The inner mask 71 and the outer mask 72 are formed with small holes 711, 721 arranged in an alternating fashion.

The inner mask 71 and the outer mask 72 of the soundproof mask 7 are ring shaped. They are formed with passage openings 712, 722 at the position corresponding to the carbon brush 3. The carbon brush 3 extends through the passage openings 712, 722 and contacts the rotor 5.

The gap between the front end of the inner mask 71 of the soundproof mask 7 and the rotor 5 is sealed by a first elastic sealing element 4. The gap between the rear end of the inner mask 71 of the soundproof mask 7 and the rotor 5 is sealed by a second sealing element 8. The rear end surface of the inner mask 71 is formed with a groove 713. The annular first sealing element 8 is disposed in the groove. The elastic sealing elements 4, 8 are made of rubber or plastic materials.

A spring is disposed outside the carbon brush 3. The spring pushes the carbon brush 3 against the rotor 5 to ensure tight contact between them.

The invention uses the soundproof mask 7 to enclose the frictional contact portion of the rotor 5 and the carbon brush 3. When noise produced by the contact between the rotor and the carbon brush is transmitted through the soundproof mask 7, it is greatly attenuated by the interference of sound waves due to the alternately arranged holes 711, 721 on the inner mask 71 and the outer mask 72. Therefore, the invention achieves the desired result of blocking noise. Moreover, the soundproof mask is located at the noise source. Therefore, it occupies a small space which reduces the production cost.

In addition, the mask 7 can contain sparks. Sparks are likely to form at the point of frictional interaction between the rotor and the carbon brush, and the inventive mask 7 blocks the sparks by forming an enclosure around this area.

In summary, the invention is advantageous because it is a simple structure that decreases noise and increases safety by blocking sparks. It thus provides good utility and is very competitive on the market.

The following claims are thus to be understood to include what is specifically illustrated and described above, what is conceptually equivalent, what can be obviously substituted and also what essentially incorporates the essential idea of the invention. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

I claim:

1. A soundproof shredder motor comprising:
a back frame;
a rotor;
a carbon brush contacting the rotor; and
a soundproof mask disposed around the rotor and a point of contact between the rotor and the carbon brush,
wherein the soundproof mask includes an inner mask and an outer mask formed with holes arranged in an alternating fashion.

2. The soundproof shredder motor of claim 1, wherein the inner mask and the outer mask of the soundproof mask are ring shaped and are formed with passage openings so that the carbon brush can pass through the passage openings to contact the rotor.

3. The soundproof shredder motor of claim 2, wherein a front end and a rear end of the soundproof mask are sealed with a first elastic sealing element and a second elastic sealing element, respectively.

4. The soundproof shredder motor of claim 1, 2, or 3, wherein there are gaps between the inner mask and the outer mask.
